(19) United States
(12) Patent Application Publication
(10) Pub. No.: US 2018/0349144 A1
(43) Pub. Date: Dec. 6, 2018

(54) METHOD AND APPARATUS FOR BRANCH PREDICTION UTILIZING PRIMARY AND SECONDARY BRANCH PREDICTORS

(71) Applicant: Intel Corporation, Santa Clara, CA (US)

(72) Inventors: Rahul Pal, Bangalore (IN); Ragavendra Natarajan, Mysore (IN); Niranjan K. Soundararajan, Bangalore (IN); Sreenivas Subramoney, Bangalore (IN); Daniel Deng, Folsom, CA (US); Jared Warner Stark, IV, Portland, OR (US); Hong Wang, Santa Clara, CA (US); Ronak Singhal, Portland, OR (US)

(73) Assignee: Intel Corporation, Santa Clara, CA (US)

(21) Appl. No.: 15/614,757

(22) Filed: Jun. 6, 2017

(51) Int. Cl. G06F 9/38

(52) U.S. Cl. CPC G06F 9/3848; G06F 9/3806

(57) ABSTRACT

In one embodiment, a processor comprises a branch predictor to generate, in association with a program loop, a frozen history vector comprising a snapshot of a branch history vector; track a current iteration of the program loop; and provide a prediction for a branch instruction associated with the program loop, the prediction based on the frozen history vector and the current iteration of the program loop.

### FIELD

The present disclosure relates in general to the field of computer development, and more specifically, to branch prediction.

### BACKGROUND

An instruction sequence of a computer program may include various branch instructions. A branch instruction is an instruction in a computer program that may cause a computer to begin executing a different instruction sequence and thus deviate from its default behavior of executing instructions in order. As an example, two-way branching may be implemented with a conditional jump instruction. A branch predictor may guess whether a branch will be taken.

A branch predictor may improve the flow in the instruction pipeline. In the absence of branch prediction, a processor would have to wait until the branch instruction (e.g., conditional jump instruction) has passed the execute stage before the next instruction could enter the fetch stage. The branch predictor attempts to avoid this wait by determining whether the branch (e.g., conditional jump) is more likely to be taken or not taken. The instruction at the most likely branch (e.g., either the next instruction in the sequence or a different instruction) is then fetched and one or more instructions starting at the predicted instruction are speculatively executed. If the processor later detects that the guess was wrong, the pipeline is flushed (resulting in the speculatively executed instructions being discarded) and the pipeline starts over with the correct instruction.

The branch predictor may keep a record (i.e., history) of whether branches are taken or not taken. When the branch predictor encounters a branch instruction that has already been seen several times, it can base the prediction on the history. The branch predictor may, for example, recognize that a branch is taken more often than not, that it is taken every other time, that it is taken every fourth time, or other suitable pattern.

### BRIEF DESCRIPTION OF THE DRAWINGS

FIG. 1 illustrates an example branch prediction unit in accordance with certain embodiments.

FIG. 2 illustrates an example flow for managing a misprediction count array in accordance with certain embodiments.

FIG. 3 illustrates an example flow for selecting a branch predictor in accordance with certain embodiments.

FIGS. 4A-4D illustrate example branch instructions associated with loops in accordance with certain embodiments.

FIG. 5 illustrates an example frozen history and iteration tracker table and example exit iteration count observation tables in accordance with certain embodiments.

FIG. 6 illustrates an example flow for managing a branch predictor at the time of branch prediction in accordance with certain embodiments.

FIG. 7 illustrates an example flow for managing a branch predictor at the time of loop entry in accordance with certain embodiments.

FIG. 8 illustrates an example flow for managing a branch predictor at the time of branch resolution in accordance with certain embodiments.

FIG. 9 illustrates an example flow for managing a branch predictor upon a determination that a branch was mispredicted in accordance with certain embodiments.

FIG. 10A is a block diagram illustrating both an exemplary in-order pipeline and an exemplary register renaming, out-of-order issue/execution pipeline in accordance with certain embodiments.

FIG. 10B is a block diagram illustrating both an exemplary embodiment of an in-order architecture core and an exemplary register renaming, out-of-order issue/execution architecture core to be included in a processor in accordance with certain embodiments;

FIGS. 11A-B illustrate a block diagram of a more specific exemplary in-order core architecture, which core would be one of several logic blocks (potentially including other cores of the same type and/or different types) in a chip in accordance with certain embodiments;

FIG. 12 is a block diagram of a processor that may have more than one core, may have an integrated memory controller, and may have integrated graphics in accordance with certain embodiments;

FIGS. 13, 14, 15, and 16 are block diagrams of exemplary computer architectures in accordance with certain embodiments; and

FIG. 17 is a block diagram contrasting the use of a software instruction converter to convert binary instructions in a source instruction set to binary instructions in a target instruction set in accordance with certain embodiments.

Like reference numbers and designations in the various drawings indicate like elements.

### DETAILED DESCRIPTION

Although the drawings depict particular computer systems, the concepts of various embodiments are applicable to any suitable integrated circuits and other logic devices. Examples of devices in which teachings of the present disclosure may be used include desktop computer systems, server computer systems, storage systems, handheld devices, tablets, other thin notebooks, systems on a chip (SOC) devices, and embedded applications. Some examples of handheld devices include cellular phones, digital cameras, media players, personal digital assistants (PDAs), and handheld PCs. Embedded applications may include a microcontroller, a digital signal processor (DSP), a system on a chip, network computers (NetPC), set-top boxes, network hubs, wide area network (WAN) switches, or any other system that can perform the functions and operations taught below. Various embodiments of the present disclosure may be used in any suitable computing environment, such as a personal computing device, a server, a mainframe, a cloud computing service provider infrastructure, a datacenter, a communications service provider infrastructure (e.g., one or more portions of an Evolved Packet Core), or other environment comprising a group of computing devices.

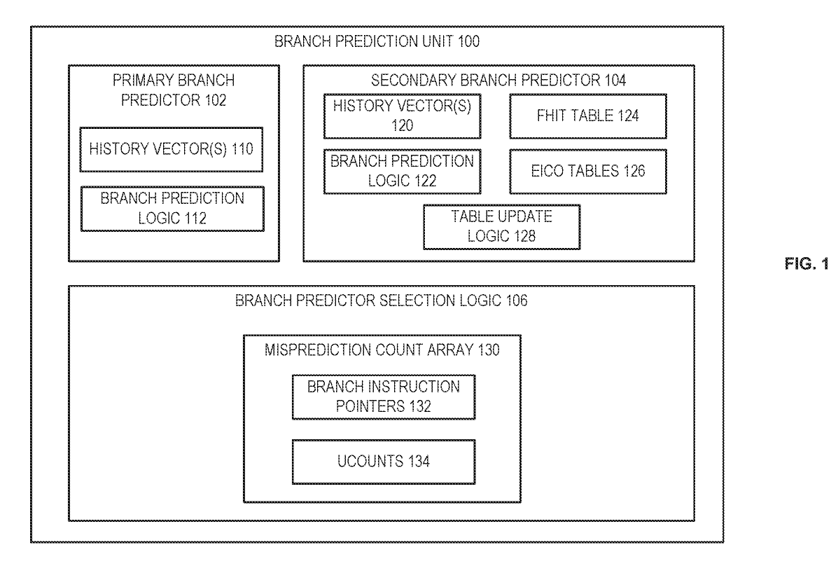

FIG. 1 illustrates an example branch prediction unit 100 in accordance with certain embodiments. Branch prediction unit 100 includes a primary branch predictor 102, a secondary branch predictor 104, and branch predictor selection logic 106. When a branch instruction is encountered, branch predictor selection logic 106 determines whether the primary branch predictor 102 or the secondary branch predictor 104 should predict the branch that is to be taken.

The branch predictor 100 may be included within or may be in communication with any type of processor operable to execute program instructions, including a general purpose microprocessor, special purpose processor, microcontroller, coprocessor, a graphics processor, accelerator, field programmable gate array (FPGA), or other type of processor (e.g., any processor described herein).

Primary branch predictor 102 may utilize any suitable branch prediction scheme(s). For example, primary branch predictor 102 may utilize one or more of an always untaken, always taken, local branch history, global branch history, one-level (e.g., Decode History Table (DHT), Branch History Table (BHT), combination DHT-BHT), two-level (e.g., Correlation Based Prediction, Two-Level Adaptive Prediction such as gshare), skewed (e.g., gskew), Tagged Geometric History Length (TAGE), or other suitable branch prediction scheme (some of the schemes listed above may utilize one or more of the other listed schemes). In a particular embodiment, branch prediction logic 112 provides branch predictions for branch instructions based on one or more branch history vectors 110 (to be described in more detail below).

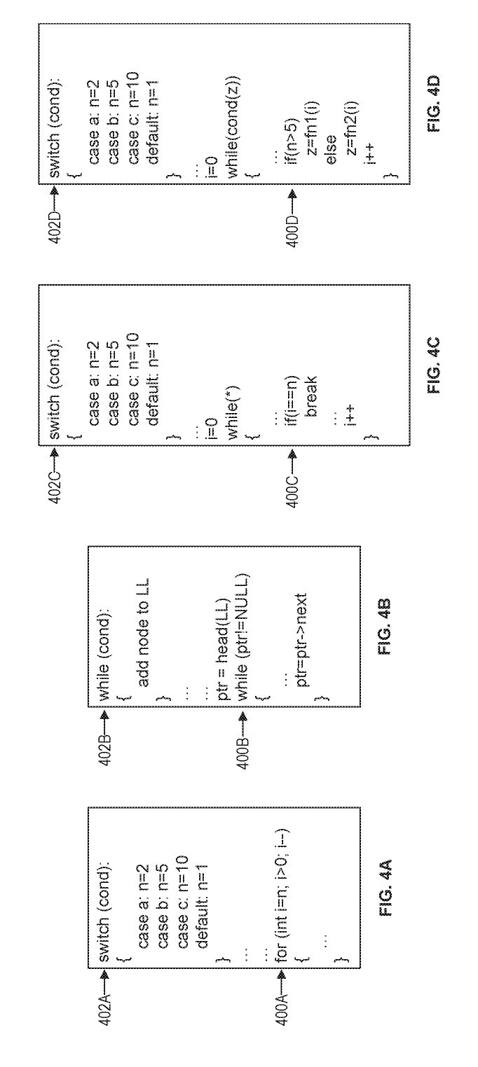

Secondary branch predictor 102 may utilize any suitable branch prediction scheme(s). For example, primary branch predictor 102 may utilize any of the branch prediction schemes mentioned above, a secondary branch prediction scheme utilized in TAGE-statistical corrector (SC) (e.g., TAGE-SC-L) or TAGE-Inner Most Loop Iteration counter (IMLI) (both of these designs use TAGE as a primary branch predictor and secondary predictors for branches that are not correlated with global history, guard loops, or guard inner most loop iterations), any secondary branch prediction scheme described herein (e.g., with respect to any of FIGS. 4-9), or other suitable branch prediction scheme.

Branch prediction accuracy is one of the key determinants of performance for a superscalar processor. In order to extract increased parallelism from a workload and complete the workload faster, the processor pipeline may be widened and/or deepened to accommodate more in-flight instructions. As the pipeline increases in size, the penalty for mispredicting the program's control flow also increases. The increased accuracy of branch predictors helps to mitigate the impact of branch misprediction penalties on large processor pipelines.

In various embodiments, the primary branch predictor 102 may be used for the majority of branch predictions while the secondary branch predictor 104 is used for certain types of branch predictions (e.g., branch instructions for which the secondary branch predictor is more likely to accurately predict the branch that should be taken). A careful selection of the branch instructions for which the prediction of the secondary branch predictor 104 is used may increase the overall accuracy of the branch prediction unit 100 and decrease the resources consumed by the associated processor. In one example, branch predictor selection logic 106 may wait until it has been demonstrated that the primary branch predictor 102 is unable to correctly predict for a particular branch instruction before using the secondary branch predictor 104 to override the primary branch predictor.

Among the branch instructions that are mispredicted, certain individual branch instructions are encountered more often and contribute disproportionately more mispredictions than the other branches. Various embodiments of the present disclosure identify branch instructions that are frequently mispredicted by the primary branch predictor 102 (e.g., those branch instructions that have disproportionately high misprediction rates relative to other branch instructions). The identified branch instructions are then predicted by secondary branch predictor 104, which may be customized to more accurately predict such branch instructions.

Workloads that are representative of typical processor usage scenarios may exhibit the following characteristics: 1) a small amount of unique branch instructions (e.g., less than 10%) may contribute a disproportionately large amount (e.g., more than 90%) of all mispredictions (branch instructions that frequently mispredict are referred to herein as the highest misprediction count (HMC) branch instructions), 2) there is usually a >90% overlap between the HMC branch instructions and branch instructions that account for 90% of the misprediction-related pipeline stalls, and 3) the mispredictions for each HMC branch instruction are distributed in time (i.e., they generally do not occur in immediate succession). The second characteristic described above supports a conclusion that reducing HMC branch misprediction will greatly benefit overall performance. The first and third characteristics form the basis for various embodiments of the present disclosure that identify the HMC branch instructions and utilize a secondary branch predictor to predict the direction to be taken for these branch instructions.

In various embodiments of the present disclosure, the number of times particular branch instructions have been mispredicted are tracked with saturating counters. Once a threshold number of mispredictions is reached (e.g., a counter for a branch instruction reaches saturation), the branch instruction is identified as an HMC branch instruction and the secondary branch predictor 104 is used to predict the branch for the HMC branch instruction.

Various embodiments may provide advantages over branch confidence mechanisms and selectors in tournament-style branch predictors. Branch confidence mechanisms examine the actual outcomes of branch instructions and compare with corresponding predictions to determine whether to increase or decrease the confidences of predictions. However, with branch confidence mechanisms, predictor entries are allocated for such branch instructions, while various embodiments of the present disclosure avoid this unnecessary behavior. Branch selectors in tournament style predictors also use the actual outcomes of branch instructions to determine which predictor to actually use at prediction time. Similar to branch confidence mechanisms, tournament selectors observe all branches and update each predictor. Various embodiments of the present disclosure do not utilize the primary branch predictor 102 for branches that are frequently mispredicted, thus reducing the amount of resources consumed.

In the embodiment depicted, branch predictor selection logic 106 includes a misprediction count array 130 that includes branch instruction pointers 132 and usefulness counts (Ucounts) 134. Although an array is depicted, any suitable data structure may be used. An entry of the misprediction count array 130 includes a pointer (e.g., address or other identifier of a branch instruction) and a corresponding Ucount. A Ucount may be an indication of a number of times that a corresponding branch instruction has been mispredicted. The size of the array 130 determines the number of HMC branch instructions that may be tracked at any point in time. During operation, the array 130 may include the HMC branch instructions.

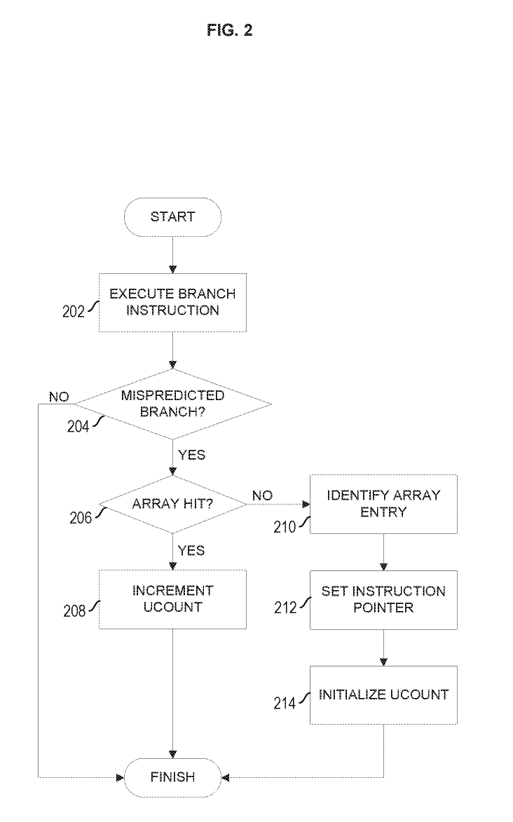

FIG. 2 illustrates an example flow for managing a misprediction count array 130 in accordance with certain embodiments. In a particular embodiment, the array 130 is written to during the retirement stage of an instruction using the prediction and outcome information (e.g., a determination of which branch is actually taken) of a branch instruction.

At 202, a branch instruction is executed. This may include making a prediction by the primary branch predictor 102 about the next instruction to execute and allowing the predicted instruction to (at least partially) move through the processor pipeline while the condition associated with the branch instruction is determined. At 204, a determination is made as to whether the branch instruction was mispredicted. If the branch instruction was not mispredicted, the flow ends and the array 130 is not updated.

If the branch was mispredicted, the flow moves to 206, where it is determined whether the branch instruction hits in the misprediction count array 130. This may be determined in any suitable manner. For example, a hit may occur when a pointer to (e.g., address or other identifier associated with) the branch instruction is stored in the array 130. In various embodiments, whether a hit occurs may be determined in any other suitable manner (e.g., based at least in part on an inference based on a structure of the array and/or values stored in the array). In general, a branch instruction may hit in the misprediction count array 130 when a Ucount for the branch instruction is stored in the array 130. If the branch instruction hits in the misprediction count array 130, the Ucount for the branch instruction is incremented at 208 in response to the determination that the branch instruction was mispredicted. In other embodiments, the Ucount may be adjusted in any suitable manner (e.g., reset, decremented, or otherwise adjusted based on the method used by the array 130 to track the number of mispredictions).

If the branch instruction does not hit in the misprediction count array 130 at 206, an entry of the misprediction count array 130 is identified at 210. The identified array entry is to be used to store a Ucount for the mispredicted branch instruction. If the entry is currently occupied by another branch instruction, then that branch instruction and associated Ucount are evicted in favor of the mispredicted branch instruction.

The array entry may be identified in any suitable manner. In one example, the misprediction count array 130 may be set associative to speed up the update process. For example, each branch instruction pointer may map to a respective subset of one or more entries of the misprediction count array 130. Any suitable size may be used for the array 130 and sets thereof. In one embodiment, the array 130 includes 256 entries and each set includes two entries. In another embodiments, the array 130 includes 256 entries and each set includes four entries. In an embodiment, the branch instruction pointer (or a portion thereof) is hashed and the resulting value is used to index into the set that is associated with the branch instruction. When a branch instruction is mispredicted, the set associated with the branch instruction is identified and an entry of the set is selected to store the Ucount of the mispredicted branch instruction.

In various embodiments, the identification of an array entry is performed by selecting the entry with the lowest Ucount of the examined entries (which could be all of the entries of the array 130 or the entries of one or more particular subsets of the array). Thus, an entry that has seen few mispredictions relative to the other examined entries may be selected for eviction. In a particular embodiment, an entry with a Ucount that is equal to an initialized value of a Ucount (which may be any suitable value and is zero in a particular embodiment) is selected. In a particular embodiment, when a Ucount of an entry is incremented and no entries of that set (or the entire array) have a Ucount value equal to the initial value of the Ucount, then all entries in that set (or the entire array) are decremented to ensure that at least one entry has a Ucount that is equal to the initial Ucount value. In another embodiment, all entries of a set or the entire array 130 may be decremented periodically.

In a particular embodiment, the identification of the array entry is performed by selecting the least recently used entry of the examined entries. For example, each entry may also include one or more bits indicating the age of the entry. In a particular embodiment, the age of an entry may be reset each time the corresponding branch instruction is mispredicted. In an embodiment, the ages of the entries of array 130 may be periodically incremented.

In a particular embodiment, when a new branch instruction is inserted into the array 130, the age may be set to the oldest age and/or the Ucount may be set to the lowest Ucount, making the branch instruction vulnerable to replacement. Since 90% of the branches are not going to mispredict often, this strategy protects branches that have mispredicted more than once or more recently from eviction.

At 212, the instruction pointer field (or other identification field) of the identified array entry is set with the address (or other identifier) of the mispredicted branch instruction (or the entry may otherwise be modified to include any suitable representation of the mispredicted branch instruction). At 214, the Ucount of entry is initialized. As various examples, the initialized Ucount value may be set to zero, one, or other suitable value.

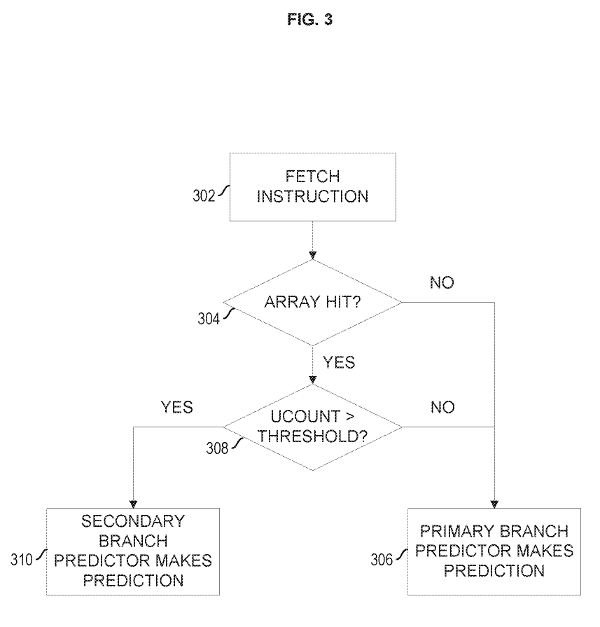

FIG. 3 illustrates an example flow for selecting a branch predictor in accordance with certain embodiments. In various embodiments the flow may be performed by any suitable logic of a processor and/or branch predictor, such as branch predictor selection logic 106, to determine, based on the state of an entry in misprediction count array 130, which branch predictor should be used to provide a prediction for a branch instruction.

In various embodiments, the array 130 may be queried for each branch instruction in an instruction stream to determine which branch predictor to use. At 302, a branch instruction is fetched. At 304, it is determined whether the branch instruction hits in the misprediction count array 130 (e.g., using any of the methods described above or other suitable methods). If the instruction does not hit in array 130, then the primary branch predictor makes the prediction for the branch instruction at 306.

If the branch instruction hits in the array 130, a determination is made as to whether the corresponding Ucount is greater than a threshold. If the Ucount is not above the threshold at 308, then the branch instruction is determined to not be an HMC branch instruction and the primary predictor makes the prediction at 306. If the Ucount is greater than the threshold, then the branch instruction is considered to be an HMC branch instruction and the secondary branch predictor 104 is used to make the prediction at 310. In a particular embodiment, if a Ucount is saturated, then the Ucount is considered to be above the threshold. For example, when a two-bit counter is used to update the Ucounts, the Ucounts may saturate at a value of three. The Ucounts may saturate at any suitable value (and the threshold value may be set accordingly) such as 3, 7, 15, 31, 63, 127, or other suitable value. In general, a lower saturation value may result in optimal identification of the HMC branches, though even at a high saturation value (e.g., 127), the array 130 may still be able to identify most if not all of the HMC branches.

As described above, any suitable type of secondary branch predictor may be used in various embodiments of the present disclosure. Particular embodiments may utilize a secondary branch predictor that is adapted to improve the prediction accuracy of branch instructions associated with program loops. In particular embodiments, misprediction count array 130 may be used to determine whether this type of secondary branch predictor is to be used to predict particular branch instructions. In other embodiments, any suitable branch predictor selection schemes may be used to determine whether this type of secondary branch predictor is to be used.

In various embodiments, any of the branch predictors (e.g., 102 and/or 104) described herein may utilize any suitable branch history vectors (e.g., history vectors 110 and 120). For various encountered branch instructions of a program, a branch history vector may include information about the state of the program when a branch instruction was encountered and whether a branch was taken or not (e.g., whether the program jumped to an instruction or whether the next instruction was executed). A branch predictor may utilize one or more global and/or local history vectors. A local history vector may include separate history buffers that each correspond to a branch instruction (e.g., a conditional jump instruction). For example, the local history vector may include entries for the previous N instances (where N may be any suitable integer) in which a particular branch instruction was encountered, where each entry includes an indication of the direction the branch instruction took. A global history vector generally does not keep a separate history record for each branch instruction (e.g., conditional jump), but instead keeps a shared history of all branch instructions. Thus, a global history may include a representation of the last X branch instructions that were encountered before the current branch instruction. The advantage of a shared history is that any correlation between different branch instructions is included in the predictions, but the history may be diluted by irrelevant information if the branch instructions are uncorrelated or if there are many other branch instructions in between the branch instruction being predicted and the correlated branch instruction.

History vectors may include any suitable information associated with previously encountered branch instructions, such as an address of the branch instruction, the branch instruction's target (e.g., an address of the branch specified by the branch instruction to be jumped to if the branch is taken), an indication of the direction the branch instruction took (e.g., a bit value indicating whether the branch was taken), any other suitable information, or any suitable representations thereof.

FIGS. 4A-4D illustrate example branch instructions associated with loops in accordance with certain embodiments. Loops are an ubiquitous part of most programs. Most dynamic instructions (including branch instructions) executed by programs are resident inside an enclosing loop's body or are otherwise associated with a loop. The outcome of many branch instructions depend on the behavior of branch instructions prior to the entry of the enclosing loop. In each of the FIGS. 4A-4D, the outcome of each branch instruction 400 (i.e., 400A, 400B, 400C, or 400D) is correlated with the outcome of a correlated branch instruction 402 (i.e., 402A, 402B, 402C, or 402D). Each branch instruction 400 resides within an enclosing loop while each branch instruction 402 resides prior to the loop. In FIGS. 4A and 4B, the branch instructions 400A and 400B are loop branch instructions (that may, e.g., branch backwards), while in FIGS. 4C and 4D, the branches 400C and 400D are each forward branch instructions inside a loop body.

The code illustrated in FIGS. 4A-4D may represent higher level code that is translated into lower level instructions specific to the processor on which the code is executed. For example, when the code represented in FIG. 4A is translated into an instruction sequence, the branch instruction 400A may be implemented by one or more instructions at the end of the loop (e.g., a jump instruction) that may jump backwards to the start of the loop when the branch is taken. Thus, if the outcome of the last instance of the branch was “taken”, the processor would continue to execute instructions inside the loop, while after the last time through the loop the branch instruction outcome would be “not taken.” As used herein, the term branch instruction may refer to either a branch instruction embodied in higher level code (such as 400A, 400B, 400C, or 400D) or a processor specific branch instruction (e.g., a jump instruction) that implements the higher level code.

FIG. 4A shows the loop branch instruction 400A to cause an exit based on a variable set by the prior branch instruction 402A. When loop branch instruction 400A is reached in the program flow, a prediction is made as to whether to stay in the loop or exit the loop. The actual determination of whether to stay in the loop or exit the loop is made after the prediction and is dependent on the value of n (which is set outside of the loop). If n is fairly large, by the time the loop is exited the program will have iterated through the loop several times. Other branch instructions inside the loop may occupy space in the global history vector that is used to predict the loop branch instruction 400A, despite not being correlated to loop branch instruction 400A. In some instances, the global history vector may not be large enough to capture the correlated branch instruction 402A.

In FIG. 4B, a linked list (LL) traversal termination depends on the outcome of branch instruction 402B that controls creation of new nodes in the linked list. For example, the point at which the second while loop is exited (when the end of the LL is reached) is determined by the size of the LL (which is dependent on when the first while loop is exited).

FIG. 4C shows a loop break condition at branch instruction 400C that is correlated to the branch instruction 402C. Branch instruction 400C represents a forward branch instruction. That is when the branch is reached, if the associated condition (in this case i==n) is met and the branch is taken, the processor will jump forward to an instruction that is not within the while loop (as opposed to jumping backward to the beginning of the loop).

FIG. 4D illustrates another forward branch 400D. In this example, z is a function of the iteration count as well as the value of n which is dependent on the outcome of branch 402D. In the example, fn1(i) and fn2(i) are function calls (in other examples, these lines of code could be direct computations). Despite being a forward branch, branch 400D has a large influence on when the while loop is exited.

In programs such as those illustrated in FIGS. 4A-4D, the global history vector might get flooded with branch instructions encountered within previous loop iterations, hampering detection of the correlations between the branch instructions. This is especially true in loops with many iterations or loops with branches within the loop body. The global history vector, when flooded by branch instructions in the previous loop iterations, may not provide accurate program context for the current branch instruction, nor capture correlations with branch instructions prior to the entry of the enclosing loop.

In a particular embodiment, secondary branch predictor 104 utilizes a frozen global history vector to provide branch predictions for branch instructions associated with loops. A frozen history vector may include a snapshot of a branch history vector at a particular time (e.g., at the time a loop is entered and/or detected). A frozen history vector may exclude any branch instructions encountered after the history was snapshotted. A secondary branch predictor that utilizes a frozen global history vector may be referred to herein as a frozen history predictor (FHP). Thus, in some embodiments, secondary branch predictor 104 comprises an FHP.

In the embodiment depicted, secondary branch predictor 104 (which may be an FHP) comprises one or more branch history vectors 120, branch prediction logic 122 which is able to make predictions for branch instructions based on information included in a frozen history and iteration tracker (FHIT) table 124 and one or more exit iteration count observation (EICO) tables 126, and table update logic 128 which is able to update FHIT table 124 and EICO tables 126 based on branch instruction predictions and outcomes and history vector(s) 120.

An FHP may preserve global correlations that existed between branch instructions prior to entering a loop and use that information to make a branch prediction at each iteration of the loop. The FHP learns and predicts branches causing or influencing loop exits (e.g., loop branches, break conditions, etc). The FHP may be used as an adjunct predictor to a primary branch predictor 102 such as TAGE or other suitable primary branch predictor (e.g., a global history based predictor). In various embodiments, the FHP does not predict every encountered branch instruction (e.g., the primary branch predictor 102 will predict in cases where correlations exist with branch instructions in the same or previous iterations of the loop which FHP does not target).

In a particular embodiment, only the most mispredicted branch instructions are predicted by the FHP while the primary branch predictor 102 predicts the remainder of the branches. Thus, as an example, a misprediction count array 130 may be used by branch predictor selection logic 106 to determine whether the FHP should be used to track and/or predict a particular branch instruction (a branch instruction may be tracked by the FHP even if the FHP is not used to predict the branch instruction). In other embodiments, selection logic 106 may use any suitable method for determining whether the FHP or the primary branch predictor 102 is used to predict a branch.

In various embodiments, a global history vector used by the primary branch predictor 102 continues to be updated with branch decisions after a loop is entered and a frozen history (i.e., snapshot) is generated. Once the loop is entered, a loop iteration count may be tracked and an indication of the iteration count at which the loop is exited (or when the outcome of the branch instruction changes even if the loop is not exited) is stored. The indication of the exit iteration may be used by the FHP to provide a prediction for a loop branch instruction (which may, at least in some embodiments, be a backward branch instruction) or a forward branch instruction associated with the loop (e.g., to provide a prediction for the branch instruction the next time the loop is entered).

The frozen history preserves the prior loop branch context which enables the FHP to find correlations in this region. The iteration count differentiates each dynamic instance of a branch instruction as it is called across successive iterations of the loop. In combination, the frozen history and iteration count also provide an accurate program context in which the to-be-predicted branch appears. When the loop exit is resolved, the FHP captures the correlation of the snapshotted global history with the iteration count at which the loop exited.

The frozen history and the iteration count at the time of a prediction for a branch instruction are used by the FHP to compare against the detected correlation to make the prediction. These two elements not only provide a very accurate picture of the program context in which the current branch instruction is encountered, but also improve the ability of the FHP to capture correlations with branch instructions that were encountered prior to the enclosing loop invocation, because branch instructions within the enclosing loop do not modify the snapshotted history and thus will not erase this information.

In various embodiments, iteration counts for each loop branch instruction and forward branch instruction may be tracked, since it may not be known in advance whether the branch instruction governs a loop exit. In various embodiments, all branch instructions may be tracked or a subset of the branch instructions may be tracked. For example, if a correlation between the snapshotted global history and exit iteration count exists, then the branch instruction may continue to be tracked and/or predicted by the FHP, but if a sufficient correlation is not seen then the FHP may stop tracking and/or making predictions on that branch. As another example, iteration counts for a branch instruction may be tracked based on a success rate of the primary branch predictor 102. For example, if the primary branch predictor 102 mispredicts a branch instruction, then an iteration count for the branch may be tracked. As another example, if the primary branch predictor 102 mispredicts a branch instruction at a frequency that is higher than a threshold (e.g., 10% or 50%), the iteration count for the branch instruction may be tracked.

Because it may be difficult to associate all branch instructions with their enclosing loop in the hardware pipeline, the FHP may attempt to identify the branch instructions that govern loop exits (i.e., the exit of the enclosing loop is usually caused by this branch instruction taking a particular direction). For backward branches (i.e., where the target instruction pointer of the branch instruction is less than the branch instruction pointer), the FHP assumes the not-taken direction is the loop exit outcome. Conversely, for forward branches (i.e., where the target instruction pointer is greater than the branch instruction pointer), the FHP assumes the taken direction results in a loop exit outcome. Successive encounters of the branch instruction where a loop exit outcome is not observed are assumed to be additional loop iterations.

Various categories of branch instructions that control the loop exit outcome and are thus targeted by the FHP include loop exit branches (e.g., 400A and 400B), including both backward and forward branches; forward branches causing loop breaks where the break causes most of the exits from the loop (e.g., 400C), and forward branches that heavily influence the loop exit branch where the loop exit branch is strongly correlated to another forward branch in the loop body (e.g., 400D).

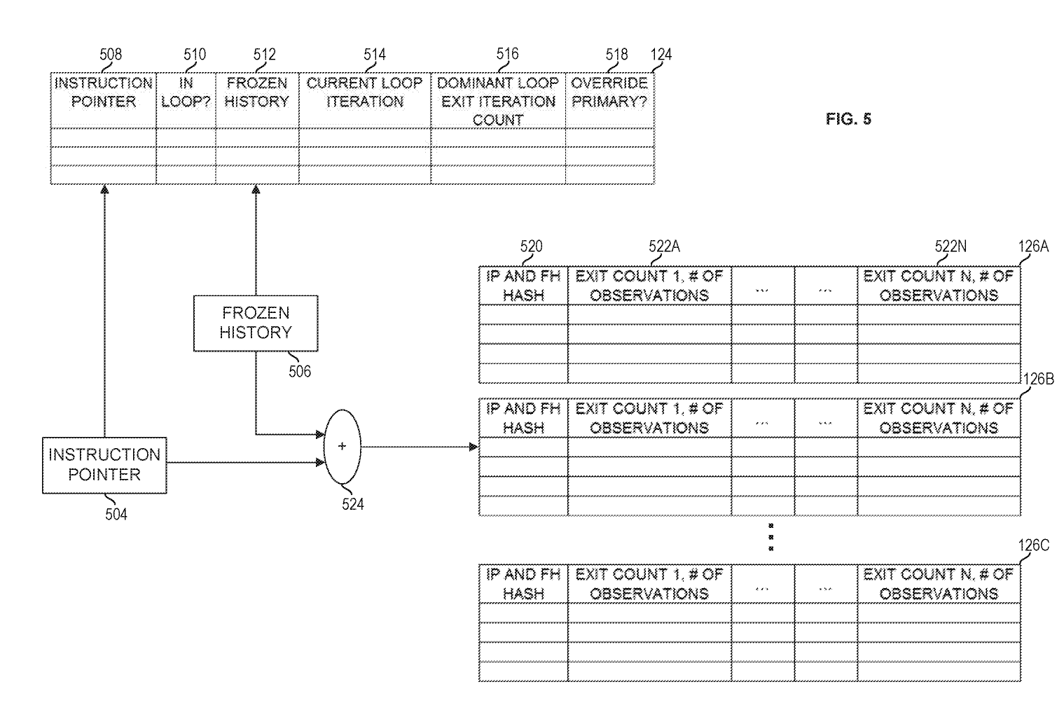

FIG. 5 illustrates an example frozen history and iteration tracker (FHIT) table 124 and example exit iteration count observation (EICO) tables (126A-126N) in accordance with certain embodiments. Secondary branch predictor 104 may include table update logic 128 to update FHIT table 124 and one or more EICO tables 126A-N.

In the embodiment depicted, each entry in the FHIT table 124 includes an instruction pointer field 508, an in loop field 510, a frozen history field 512, a current loop iteration field 514, a dominant loop exit iteration count field 516, and an override primary field 518. The instruction pointer field 508 is to store an instruction pointer (e.g., address or other identifier) of a branch instruction, the in loop field 510 is to store an indication of whether the branch instruction is currently in a loop (e.g., being executed within a loop), the frozen history field 512 is to store a copy (or other representation) of a frozen history vector (i.e., a snapshot of the global history vector taken at the first iteration of a loop), dominant loop exit iteration count 516 is to store an indication of the iteration number at which the most exit outcomes have been observed for the particular branch instruction and frozen history, and override primary field 518 includes an indication of whether the primary branch predictor 102 or the FHP should be used to predict the outcome of the branch (e.g., this value may indicate whether the dominant loop exit iteration count is good enough to use for the branch prediction).

The instruction pointer (IP) of a branch instruction is used to index into the FHIT table 124. The FHIT table 124 is updated at the prediction stage of the pipeline. The FHIT table 124 tracks the loop iteration count for an IP by incrementing the iteration count every time the IP is encountered and an exit outcome is not predicted by the branch prediction unit 100. A predicted exit outcome resets the iteration count. In the case of a misprediction of the branch instruction, the correct iteration count is restored based on the real outcome of that instance of the branch instruction. At the entry of a new loop for the IP (e.g., when the IP is first encountered or next encountered after an exit outcome), the global history is snapshotted and captured in the frozen history field 512 in the FHIT table 124.

When a loop is entered (i.e., when the branch instruction encountered for the first time or when the branch instruction is encountered after a loop exit is detected), the frozen history is captured, and at each iteration the dominant loop exit iteration count is compared against the current loop iteration value. Since the history may be frozen at the end of the first iteration of the loop, the snapshot of the history may include the first iteration of the loop.

The secondary branch predictor 104 may also maintain one or more EICO tables 126. An EICO table 126 includes a field that stores a unique value based on the IP of the branch instruction and a corresponding frozen history (FH). For example, an EICO table 126 may include an IP and FH hash field 520. In a particular embodiment, logic 524 implements a hash function that accepts an IP and FH as inputs and outputs a hash value (that is more compact than the combination of the IP and the FH) that may be stored in the IP and FH hash field 520 of an entry or used to index into an EICO table 126 if an entry for the IP and FH combination already exists. In a particular embodiment, the EICO table(s) only track IPs included in the FHIT.

An EICO table 126 may also include one or more fields 522A-N that are each to store an exit count (also referred to herein as a loop exist iteration count) that corresponds to the value of the current loop iteration value when an exit outcome was observed and a number of times that particular exit count has been observed for the particular branch instruction and frozen history combination. Field 522A may include a first exit count and a number of times that exit count has been observed for a first IP and FH combination, field 522B may include a second exit count and a number of times that exit count has been observed for the same IP and FH combination, and so on. As one example, for the same IP and FH combination, field 522A may indicate that an exit outcome was observed twenty times on iteration number seven, field 522B may indicate that an exit outcome was observed ninety three times on iteration number ten, etc.

In various embodiments, secondary branch predictor 104 may maintain multiple EICO tables 126 that each utilize a different length of frozen history (e.g., 10 branches, 20 branches, 50 branches, etc.). For example, the entries of EICO table 126A may include IP and FH hash values formed by hashing IPs with corresponding frozen histories that are 10 branches in length, the entries of EICO table 126B may include IP and FH hash values formed by hashing IPs with corresponding frozen histories that are 20 branches in length, and so on. In a particular embodiment, one of the EICO tables corresponds to a frozen history length that is equal to the history length of a global history vector utilized by primary branch predictor 102, though in another embodiment the frozen history lengths used by the EICO tables may all be different from the length of the global history vector. The various frozen histories corresponding to the EICO tables 126 may be subsets of the copy of the frozen history stored in the frozen history field 512. For example, the first 10 branches of the frozen history may be used in combination with the IP to index into a first EICO table, the first 20 branches of the frozen history may be used in combination with the IP to index into a second EICO table, the first 50 branches of the frozen history may be used in combination with the IP to index into a third EICO table, etc. (although various lengths are used in this example, in other embodiments, EICO tables 126 may correspond to any suitable frozen history lengths). Thus, various subsets of the frozen history stored in the frozen history field 512 and/or the entire frozen history may each correspond to a particular EICO table 126.

An EICO table 126 may be updated after either the execute stage of the pipeline or at the instruction retirement stage. In case an exit outcome is seen for a branch instruction at the time the EICOs are updated, the iteration count at which the exit is seen (i.e., the exit count) is stored in a field 522 corresponding to the IP and the frozen history associated with this exit (or the number of observations for the exit count is incremented if the exit count is already stored). The iteration count and frozen history may be read from the FHIT during prediction of this branch IP instance by the FHP and passed through the pipeline for this purpose. If a large majority of exits seen for a particular IP and frozen history combination are seen with the same exit iteration count, a strong correlation exists between this frozen history and the exit count (for this IP) and the FHP may be used to predict this branch.

At the time of loop entry during a pipeline prediction stage, when the frozen history is captured and written to the FHIT table 124, the EICO tables are also accessed. If a table entry contains a strongly correlating exit count (e.g., an exit is occurring at a particular iteration a majority of the time for the particular branch IP and frozen history), then this exit count may be written as the dominant loop exit iteration count in the FHIT table 124. Among the different entries that correspond to the particular branch IP and respective frozen histories in the EICO tables, the exit count with the strongest correlation is chosen (e.g., the exit count that is observed at the highest rate of observed exit counts for the particular IP and FH combination). As an alternative, the exit count with the strongest correlation from the EICO table corresponding to the longest frozen history may be used (since this EICO table is generally the most accurate). As the IP is encountered in successive loop iterations, if the iteration count matches this stored exit iteration count (i.e., the value in field 516) an exit outcome is predicted by the FHP, otherwise the branch direction opposite to the exit outcome is predicted by the FHP. If none of the EICO tables contained a strongly correlating exit iteration count, the FHIT entry may be marked as incapable of making a prediction for the current loop (e.g., the override primary field 518 may be set to false) and the prediction from the primary branch predictor 102 will be used.

When an EICO table 126 is full, an entry of the EICO table may be evicted in favor of a new IP and FH combination. The EICO tables corresponding to longer frozen histories may have a higher thrashing rate because there is more variability in the frozen histories as their lengths increase. Accordingly, the probability of hitting such tables is lower than the probability of hitting in the EICO tables corresponding to shorter frozen histories, but these tables are generally more accurate due to the increased frozen history length.

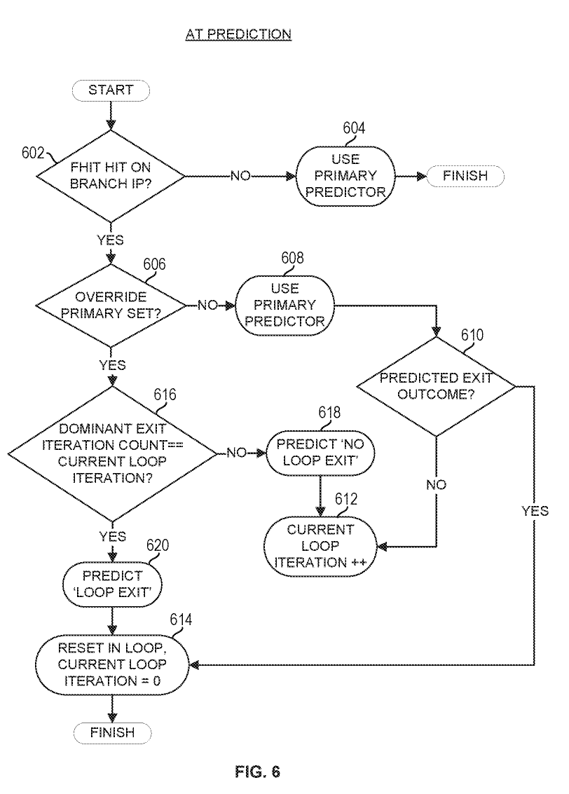

FIG. 6 illustrates an example flow for managing a frozen history branch predictor (i.e., FHP) at the time of branch prediction in accordance with certain embodiments. At 602, a determination is made on whether an IP of a branch instruction hits in the FHIT table 124, that is, whether the FHIT table 124 includes an entry dedicated to the IP (e.g., the entry may include the IP or a representation thereof). If the branch IP does not hit in the FHIT table 124, then the primary branch predictor 102 is used to predict the branch at 604 and the flow ends.

If the branch IP hits in the FHIT table 124, but a determination is made that the override primary field of the entry for the branch IP is set to false, the primary branch predictor is used to predict the branch at 608. It is then determined whether the primary branch predictor predicted an exit outcome (e.g., an exit outcome may be detected when the branch prediction was “not taken” if the branch instruction is a backward branch instruction or “taken” if the branch instruction is a forward branch instruction). If it is determined at 610 that an exit outcome was not predicted, the current loop iteration value of the corresponding entry of the FHIT table 124 is incremented at 612 and the flow ends. If it is determined at 610 that an exit outcome was predicted, the in loop field 510 of the entry of the FHIT table is reset and the current loop iteration value of the entry is set to 0 (since a prediction was made at 610 that the loop has been exited).

At 606, if it is determined that the override primary field is set, then a determination is made at 616 as to whether the dominant loop exit iteration count is equal to the current loop iteration value. If these values are not equal, then at 618, the FHP predicts that the loop is not exited at 618. For a backward branch instruction, this may result in a prediction that the backwards branch is to be taken. Conversely for a forward branch instruction, this may result in a prediction that the forward branch is not to be taken. At 612, the current loop iteration value is incremented and the flow ends.

At 616, if it is determined that the dominant loop exit iteration count is equal to the current loop iteration value, then the FHP predicts that the loop is exited at 620. For a backward branch, this may result in a prediction that the backward branch is not to be taken. Conversely for a forward branch, this may result in a prediction that the forward branch is to be taken. At 614, the in loop value is reset and the current loop iteration is set to 0.

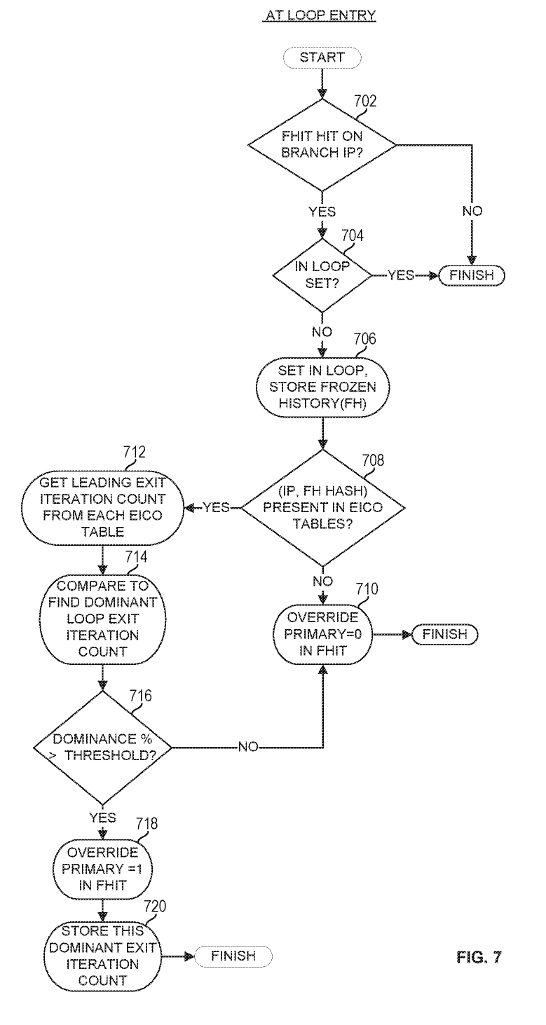

FIG. 7 illustrates an example flow for managing a frozen history branch predictor at the time of loop entry in accordance with certain embodiments. At 702, a determination is made as to whether the branch IP hits in the FHIT table 124. If it does not, the flow ends. If the branch IP hits in the FHIT table, at 704 a determination is made as to whether the in loop value of the corresponding entry in the FHIT table 124 is set. If it is, the flow ends. If the in loop value is not set, the in loop value is set, a frozen history is captured, and the frozen history is stored at 706. In various embodiments, various lengths of frozen histories are captured and stored at this operation. At 708, a determination is made as to whether an entry dedicated to a combination of the branch IP and the frozen history (e.g., a hash of the IP and the FH) is present in an EICO table. In various embodiments, multiple EICO tables corresponding to varying frozen history lengths may be checked to see if any of them have an entry for the combination of the branch IP and corresponding frozen history. If no entry exists in an EICO table, the override primary field in the corresponding entry of the FHIT table is set to 0 (i.e., false) at 710 and the flow finishes.

If at least one matching entry exists in at least one EICO table at 708, the leading exit iteration count (e.g., the highest exit count present in one of fields 522 for the particular IP and frozen history) from each EICO table is obtained at 712 and the dominant loop exit iteration count is selected at 714. In a particular embodiment, a dominance value is calculated for each leading exit iteration count obtained at 712. As one example, the dominance value may be a dominance percentage calculated by dividing the number of times that the exit iteration count was observed by the total number of exit outcomes observed (e.g., the sum of the number of observations in each field 522 of the matching entry of the EICO table). In another embodiment, the dominant loop exit iteration count may simply be the leading exit iteration count from the matching entry in the EICO table that corresponds to the longest frozen history length. The dominant loop exit iteration count may be selected in any other suitable manner based on the exit counts and number of times observed.

At 716, it is determined whether the dominance percentage (i.e., the frequency with which the dominant loop exit iteration count was observed at loop exit of the branch instruction relative to other iteration counts that coincided with loop exits) exceeds a particular percentage. Any suitable percentage may be specified as the threshold percentage for comparison against the dominance percentage. In a particular embodiment, the threshold percentage could be based on a percentage that the primary branch predictor has mispredicted the branch (e.g., if the global branch predictor mispredicts the branch 50% of the time the threshold percentage may be set to 50% such that the FHP may be used when the FHP is expected to correctly predict the branch more than 50% of the time). In another embodiment, the threshold percentage may be set to any suitable value, such as 60%, 75%, or other suitable value. If the dominance percentage is not greater than the threshold percentage at 716, then the override primary value may be set to 0 (i.e., false) in the FHIT table at 710 (so that the primary branch predictor 102 will be used to predict the branch) and the flow ends. If the dominance percentage is greater than the threshold percentage at 716, then the override primary value is set to 1 (i.e., true) in the FHIT table at 718, the dominant loop exit iteration count is stored in the FHIT table at 720, and the flow ends.

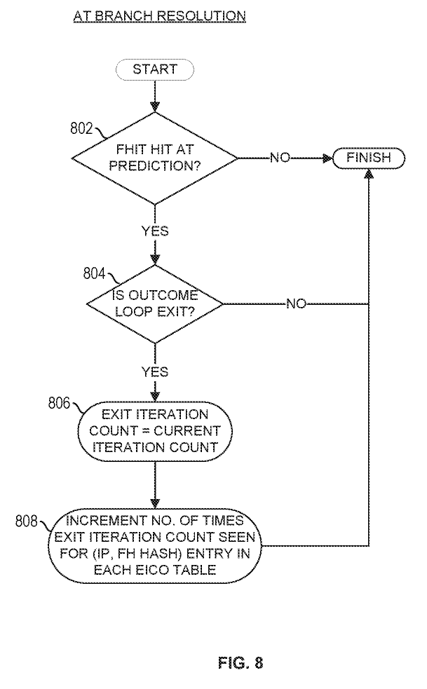

FIG. 8 illustrates an example flow for managing a frozen history branch predictor at the time of branch resolution in accordance with certain embodiments. The time of branch resolution refers to the time at which it is determined whether the branch prediction was correct.

At 802, a determination is made as to whether the branch IP hit (in the FHIT table) at the time of prediction. If it did not, the flow ends. If the branch IP did hit, a determination is made at 804 as to whether the outcome of the branch was a loop exit. If the outcome indicates there was no loop exit, the flow finishes. If the outcome indicates there was a loop exit, then the exit iteration count is set equal to the current iteration count at 806 and the number of times the particular exit iteration count has been observed is incremented for each entry corresponding to the branch IP and corresponding frozen history in each EICO table at 808. If an entry does not exist in an EICO table for the branch IP and corresponding frozen history, then an entry may be created at 808 and the number of times the particular exit iteration count has been observed is initialized (e.g., to zero or one).

In various embodiments, this flow may involve sending the various frozen histories (i.e., the frozen histories of various lengths) and the current iteration count from the front end of a processor to the back end (e.g., execution engine) of the processor so that when the actual outcome is resolved at the back end of the processor the entries of the EICO table can be updated properly.

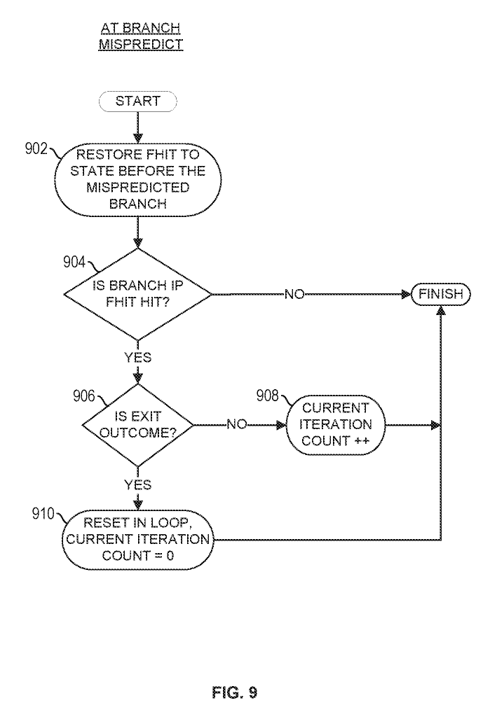

FIG. 9 illustrates an example flow for managing a frozen history branch predictor upon a determination that a branch was mispredicted in accordance with certain embodiments. At 902, upon a determination that a branch was mispredicted, the FHIT table is restored to the state it was in before the branch was mispredicted. At 904, a determination is made as to whether the branch IP hits in the restored FHIT table. If it does not, the flow ends. If the branch IP does hit in the restored FHIT table, a determination is made as to whether the actual outcome is an exit at 906. If the actual outcome is not an exit then the current iteration count in the FHIT table is incremented at 908. If the actual outcome is an exit, then the in loop value for the entry of the branch IP in the FHIT table is reset and the current iteration count is set to 0 at 910 and the flow ends.

In various embodiments, this flow may involve storing an indication of the state of the FHIT table such that the FHIT table may be restored if there is a misprediction. In a particular embodiment, branch prediction unit 100 stores a record of the changes to the FHIT table that have occurred since the branch instruction was originally predicted in order to save space (though in other embodiments, the original state of the entire FHIT table may be stored).

The flows described in FIGS. 2-3 and 6-9 are merely representative of operations that may occur in particular embodiments. In other embodiments, additional operations may be performed by the components of branch prediction unit 100. Various embodiments of the present disclosure contemplate any suitable signaling mechanisms for accomplishing the functions described herein. Some of the operations illustrated in FIGS. 2-3 and 6-9 may be repeated, combined, modified or deleted where appropriate. Additionally, operations may be performed in any suitable order without departing from the scope of particular embodiments. In various embodiments, any one or more operations of a particular flow depicted herein may be performed simultaneously with one or more operations of another particular flow depicted herein.

The figures below detail exemplary architectures and systems to implement embodiments of the above. For example, any of the processors described below may include any of the branch predictors described herein. In some embodiments, one or more hardware components and/or instructions described above are emulated as detailed below, or implemented as software modules.

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures.

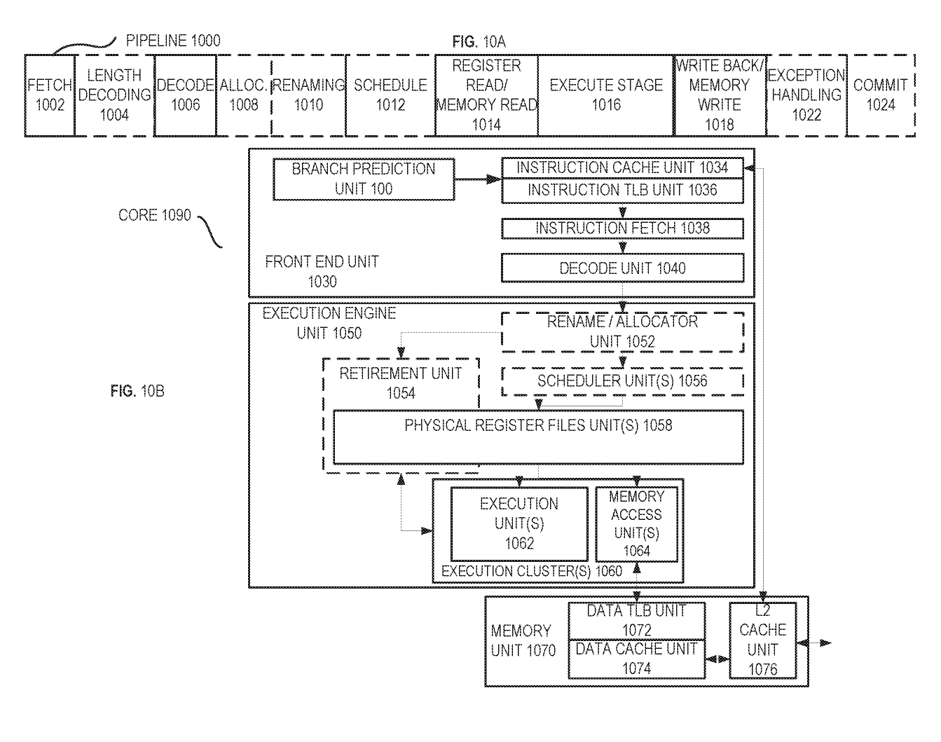

FIG. 10A is a block diagram illustrating both an exemplary in-order pipeline and an exemplary register renaming, out-of-order issue/execution pipeline according to embodiments of the disclosure. FIG. 10B is a block diagram illustrating both an exemplary embodiment of an in-order architecture core and an exemplary register renaming, out-of-order issue/execution architecture core to be included in a processor according to embodiments of the disclosure. The solid lined boxes in FIGS. 10A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 10A, a processor pipeline 1000 includes a fetch stage 1002, a length decode stage 1004, a decode stage 1006, an allocation stage 1008, a renaming stage 1010, a scheduling (also known as a dispatch or issue) stage 1012, a register read/memory read stage 1014, an execute stage 1016, a write back/memory write stage 1018, an exception handling stage 1022, and a commit stage 1024.

FIG. 10B shows processor core 1090 including a front end unit 1030 coupled to an execution engine unit 1050, and both are coupled to a memory unit 1070. The core 1090 may be a reduced instruction set computing (RISC) core, a complex instruction set computing (CISC) core, a very long instruction word (VLIW) core, or a hybrid or alternative core type. As yet another option, the core 1090 may be a special-purpose core, such as, for example, a network or communication core, compression and/or decompression engine, coprocessor core, general purpose computing graphics processing unit (GPGPU) core, graphics core, or the like.

The front end unit 1030 includes a branch prediction unit 100 coupled to an instruction cache unit 1034, which is coupled to an instruction translation lookaside buffer (TLB) 1036, which is coupled to an instruction fetch unit 1038, which is coupled to a decode unit 1040. In various embodiments, at least a portion of the logic of the branch prediction unit 100 (e.g., logic that modifies the FHIT table upon branch resolution) may be located in the execution engine unit 1050. The decode unit 1040 (or decoder) may decode instructions, and generate as an output one or more micro-operations, micro-code entry points, microinstructions, other instructions, or other control signals, which are decoded from, or which otherwise reflect, or are derived from, the original instructions. The decode unit 1040 may be implemented using various different mechanisms. Examples of suitable mechanisms include, but are not limited to, look-up tables, hardware implementations, programmable logic arrays (PLAs), microcode read only memories (ROMs), etc. In one embodiment, the core 1090 includes a microcode ROM or other medium that stores microcode for certain macroinstructions (e.g., in decode unit 1040 or otherwise within the front end unit 1030). The decode unit 1040 is coupled to a rename/allocator unit 1052 in the execution engine unit 1050.

The execution engine unit 1050 includes the rename/allocator unit 1052 coupled to a retirement unit 1054 and a set of one or more scheduler unit(s) 1056. The scheduler unit(s) 1056 represents any number of different schedulers, including reservations stations, central instruction window, etc. The scheduler unit(s) 1056 is coupled to the physical register file(s) unit(s) 1058. Each of the physical register file(s) units 1058 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 1058 comprises a vector registers unit, a write mask registers unit, and a scalar registers unit. These register units may provide architectural vector registers, vector mask registers, and general purpose registers. The physical register file(s) unit(s) 1058 is overlapped by the retirement unit 1054 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 1054 and the physical register file(s) unit(s) 1058 are coupled to the execution cluster(s) 1060. The execution cluster(s) 1060 includes a set of one or more execution units 1062 and a set of one or more memory access units 1064. The execution units 1062 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 1056, physical register file(s) unit(s) 1058, and execution cluster(s) 1060 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 1064). It should also be understood that where separate pipelines are used, one or more of these pipelines may be out-of-order issue/execution and the rest in-order.

The set of memory access units 1064 is coupled to the memory unit 1070, which includes a data TLB unit 1072 coupled to a data cache unit 1074 coupled to a level 2 (L2) cache unit 1076. In one exemplary embodiment, the memory access units 1064 may include a load unit, a store address unit, and a store data unit, each of which is coupled to the data TLB unit 1072 in the memory unit 1070. The instruction cache unit 1034 is further coupled to a level 2 (L2) cache unit 1076 in the memory unit 1070. The L2 cache unit 1076 is coupled to one or more other levels of cache and eventually to a main memory.

By way of example, the exemplary register renaming, out-of-order issue/execution core architecture may implement the pipeline 1000 as follows: 1) the instruction fetch 1038 performs the fetch and length decoding stages 1002 and 1004; 2) the decode unit 1040 performs the decode stage 1006; 3) the rename/allocator unit 1052 performs the allocation stage 1008 and renaming stage 1010; 4) the scheduler unit(s) 1056 performs the schedule stage 1012; 5) the physical register file(s) unit(s) 1058 and the memory unit 1070 perform the register read/memory read stage 1014; the execution cluster 1060 perform the execute stage 1016; 6) the memory unit 1070 and the physical register file(s) unit(s) 1058 perform the write back/memory write stage 1018; 7) various units may be involved in the exception handling stage 1022; and 8) the retirement unit 1054 and the physical register file(s) unit(s) 1058 perform the commit stage 1024.

The core 1090 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 1090 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 1034/1074 and a shared L2 cache unit 1076, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

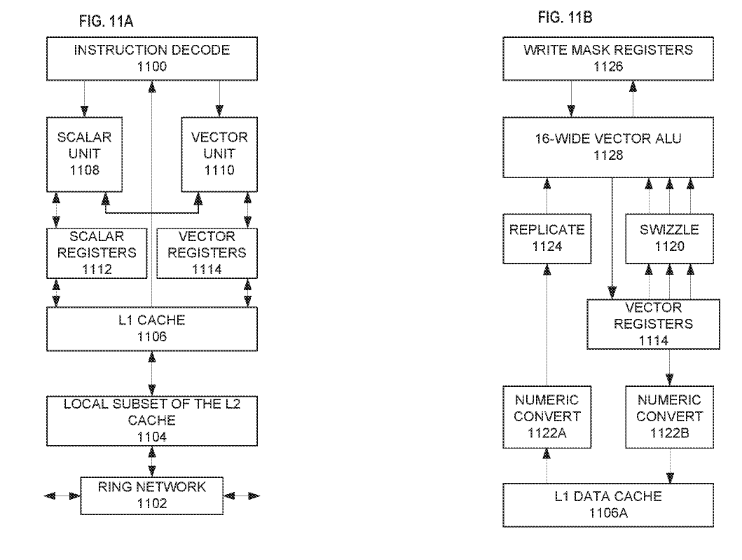

FIGS. 11A-B illustrate a block diagram of a more specific exemplary in-order core architecture, which core would be one of several logic blocks (potentially including other cores of the same type and/or different types) in a chip. The logic blocks communicate through a high-bandwidth interconnect network (e.g., a ring network) with some fixed function logic, memory I/O interfaces, and other necessary I/O logic, depending on the application.

FIG. 11A is a block diagram of a single processor core, along with its connection to the on-die interconnect network 1102 and with its local subset of the Level 2 (L2) cache 1104, according to various embodiments. In one embodiment, an instruction decoder 1100 supports the x86 instruction set with a packed data instruction set extension. An L1 cache 1106 allows low-latency accesses to cache memory into the scalar and vector units. While in one embodiment (to simplify the design), a scalar unit 1108 and a vector unit 1110 use separate register sets (respectively, scalar registers 1112 and vector registers 1114) and data transferred between them is written to memory and then read back in from a level 1 (L1) cache 1106, alternative embodiments may use a different approach (e.g., use a single register set or include a communication path that allow data to be transferred between the two register files without being written and read back).

The local subset of the L2 cache 1104 is part of a global L2 cache that is divided into separate local subsets (in some embodiments one per processor core). Each processor core has a direct access path to its own local subset of the L2 cache 1104. Data read by a processor core is stored in its L2 cache subset 1104 and can be accessed quickly, in parallel with other processor cores accessing their own local L2 cache subsets. Data written by a processor core is stored in its own L2 cache subset 1104 and is flushed from other subsets, if necessary. The ring network ensures coherency for shared data. The ring network is bi-directional to allow agents such as processor cores, L2 caches and other logic blocks to communicate with each other within the chip. In a particular embodiment, each ring data-path is 1012-bits wide per direction.

FIG. 11B is an expanded view of part of the processor core in FIG. 11A according to embodiments. FIG. 11B includes an L1 data cache 1106A (part of the L1 cache 1106), as well as more detail regarding the vector unit 1110 and the vector registers 1114. Specifically, the vector unit 1110 is a 16-wide vector processing unit (VPU) (see the 16-wide ALU 1128), which executes one or more of integer, single-precision float, and double-precision float instructions. The VPU supports swizzling the register inputs with swizzle unit 1120, numeric conversion with numeric convert units 1122A-B, and replication with replication unit 1124 on the memory input. Write mask registers 1126 allow predicating resulting vector writes.

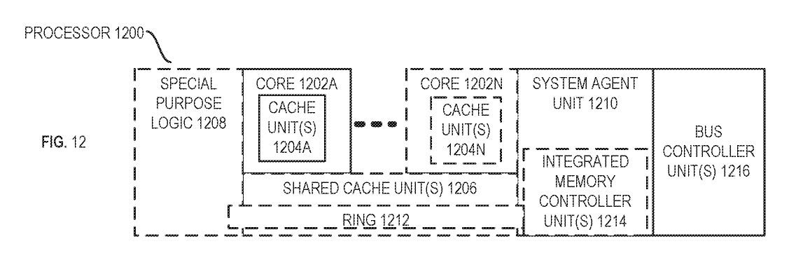

FIG. 12 is a block diagram of a processor 1200 that may have more than one core, may have an integrated memory controller, and may have integrated graphics according to various embodiments. The solid lined boxes in FIG. 12 illustrate a processor 1200 with a single core 1202A, a system agent 1210, and a set of one or more bus controller units 1216; while the optional addition of the dashed lined boxes illustrates an alternative processor 1200 with multiple cores 1202A-N, a set of one or more integrated memory controller unit(s) 1214 in the system agent unit 1210, and special purpose logic 1208.

Thus, different implementations of the processor 1200 may include: 1) a CPU with the special purpose logic 1208 being integrated graphics and/or scientific (throughput) logic (which may include one or more cores), and the cores 1202A-N being one or more general purpose cores (e.g., general purpose in-order cores, general purpose out-of-order cores, or a combination of the two); 2) a coprocessor with the cores 1202A-N being a large number of special purpose cores intended primarily for graphics and/or scientific (throughput); and 3) a coprocessor with the cores 1202A-N being a large number of general purpose in-order cores. Thus, the processor 1200 may be a general-purpose processor, coprocessor or special-purpose processor, such as, for example, a network or communication processor, compression and/or decompression engine, graphics processor, GPGPU (general purpose graphics processing unit), a high-throughput many integrated core (MIC) coprocessor (e.g., including 30 or more cores), embedded processor, or other fixed or configurable logic that performs logical operations. The processor may be implemented on one or more chips. The processor 1200 may be a part of and/or may be implemented on one or more substrates using any of a number of process technologies, such as, for example, BiCMOS, CMOS, or NMOS.

In various embodiments, a processor may include any number of processing elements that may be symmetric or asymmetric. In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core may refer to logic located on an integrated circuit capable of maintaining an independent architectural state, wherein each independently maintained architectural state is associated with at least some dedicated execution resources. A hardware thread may refer to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

The memory hierarchy includes one or more levels of cache within the cores, a set or one or more shared cache units 1206, and external memory (not shown) coupled to the set of integrated memory controller units 1214. The set of shared cache units 1206 may include one or more mid-level caches, such as level 2 (L2), level 3 (L3), level 4 (L4), or other levels of cache, a last level cache (LLC), and/or combinations thereof. While in one embodiment a ring based interconnect unit 1212 interconnects the special purpose logic (e.g., integrated graphics logic) 1208, the set of shared cache units 1206, and the system agent unit 1210/integrated memory controller unit(s) 1214, alternative embodiments may use any number of well-known techniques for interconnecting such units. In one embodiment, coherency is maintained between one or more cache units 1206 and cores 1202A-N.

In some embodiments, one or more of the cores 1202A-N are capable of multi-threading. The system agent 1210 includes those components coordinating and operating cores 1202A-N. The system agent unit 1210 may include for example a power control unit (PCU) and a display unit. The PCU may be or include logic and components needed for regulating the power state of the cores 1202A-N and the special purpose logic 1208. The display unit is for driving one or more externally connected displays.

The cores 1202A-N may be homogenous or heterogeneous in terms of architecture instruction set; that is, two or more of the cores 1202A-N may be capable of executing the same instruction set, while others may be capable of executing only a subset of that instruction set or a different instruction set.

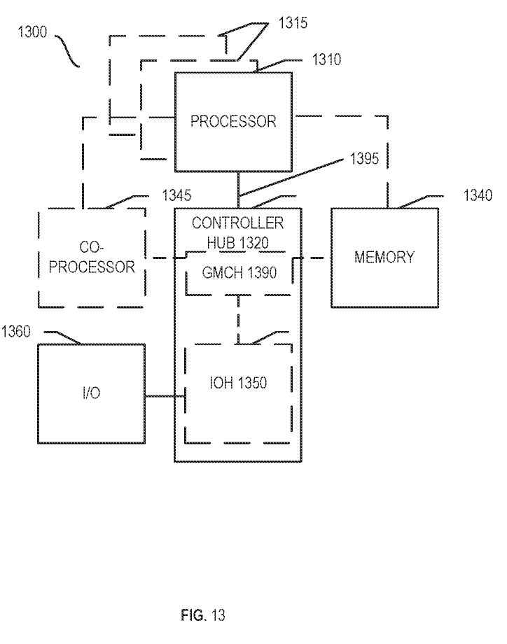

FIGS. 13-16 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable for performing the methods described in this disclosure. In general, a huge variety of systems or electronic devices capable of incorporating a processor and/or other execution logic as disclosed herein are generally suitable.

FIG. 13 depicts a block diagram of a system 1300 in accordance with one embodiment of the present disclosure. The system 1300 may include one or more processors 1310, 1315, which are coupled to a controller hub 1320. In one embodiment the controller hub 1320 includes a graphics memory controller hub (GMCH) 1390 and an Input/Output Hub (IOH) 1350 (which may be on separate chips or the same chip); the GMCH 1390 includes memory and graphics controllers coupled to memory 1340 and a coprocessor 1345; the IOH 1350 couples input/output (I/O) devices 1360 to the GMCH 1390. Alternatively, one or both of the memory and graphics controllers are integrated within the processor (as described herein), the memory 1340 and the coprocessor 1345 are coupled directly to the processor 1310, and the controller hub 1320 is a single chip comprising the IOH 1350.

The optional nature of additional processors 1315 is denoted in FIG. 13 with broken lines. Each processor 1310, 1315 may include one or more of the processing cores described herein and may be some version of the processor 1200.

The memory 1340 may be, for example, dynamic random access memory (DRAM), phase change memory (PCM), other suitable memory, or any combination thereof. The memory 1340 may store any suitable data, such as data used by processors 1310, 1315 to provide the functionality of computer system 1300. For example, data associated with programs that are executed or files accessed by processors 1310, 1315 may be stored in memory 1340. In various embodiments, memory 1340 may store data and/or sequences of instructions that are used or executed by processors 1310, 1315.

In at least one embodiment, the controller hub 1320 communicates with the processor(s) 1310, 1315 via a multi-drop bus, such as a frontside bus (FSB), point-to-point interface such as QuickPath Interconnect (QPI), or similar connection 1395.

In one embodiment, the coprocessor 1345 is a special-purpose processor, such as, for example, a high-throughput MIC processor, a network or communication processor, compression and/or decompression engine, graphics processor, GPGPU, embedded processor, or the like. In one embodiment, controller hub 1320 may include an integrated graphics accelerator.

There can be a variety of differences between the physical resources 1310, 1315 in terms of a spectrum of metrics of merit including architectural, microarchitectural, thermal, power consumption characteristics, and the like.

In one embodiment, the processor 1310 executes instructions that control data processing operations of a general type. Embedded within the instructions may be coprocessor instructions. The processor 1310 recognizes these coprocessor instructions as being of a type that should be executed by the attached coprocessor 1345. Accordingly, the processor 1310 issues these coprocessor instructions (or control signals representing coprocessor instructions) on a coprocessor bus or other interconnect, to coprocessor 1345. Coprocessor(s) 1345 accept and execute the received coprocessor instructions.

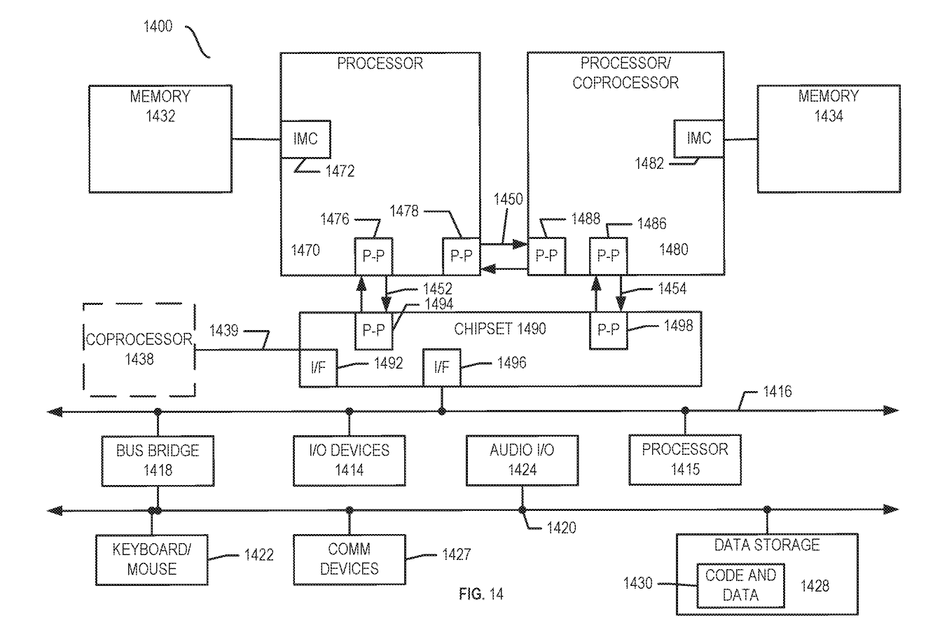

FIG. 14 depicts a block diagram of a first more specific exemplary system 1400 in accordance with an embodiment of the present disclosure. As shown in FIG. 14, multiprocessor system 1400 is a point-to-point interconnect system, and includes a first processor 1470 and a second processor 1480 coupled via a point-to-point interconnect 1450. Each of processors 1470 and 1480 may be some version of the processor 1200. In one embodiment of the disclosure, processors 1470 and 1480 are respectively processors 1310 and 1315, while coprocessor 1438 is coprocessor 1345. In another embodiment, processors 1470 and 1480 are respectively processor 1310 and coprocessor 1345.

Processors 1470 and 1480 are shown including integrated memory controller (IMC) units 1472 and 1482, respectively. Processor 1470 also includes as part of its bus controller units point-to-point (P-P) interfaces 1476 and 1478; similarly, second processor 1480 includes P-P interfaces 1486 and 1488. Processors 1470, 1480 may exchange information via a point-to-point (P-P) interface 1450 using P-P interface circuits 1478, 1488. As shown in FIG. 14, IMCs 1472 and 1482 couple the processors to respective memories, namely a memory 1432 and a memory 1434, which may be portions of main memory locally attached to the respective processors.

Processors 1470, 1480 may each exchange information with a chipset 1490 via individual P-P interfaces 1452, 1454 using point to point interface circuits 1476, 1494, 1486, 1498. Chipset 1490 may optionally exchange information with the coprocessor 1438 via a high-performance interface 1439. In one embodiment, the coprocessor 1438 is a special-purpose processor, such as, for example, a high-throughput MIC processor, a network or communication processor, compression and/or decompression engine, graphics processor, GPGPU, embedded processor, or the like.

A shared cache (not shown) may be included in either processor or outside of both processors, yet connected with the processors via a P-P interconnect, such that either or both processors' local cache information may be stored in the shared cache if a processor is placed into a low power mode.

Chipset 1490 may be coupled to a first bus 1416 via an interface 1496. In one embodiment, first bus 1416 may be a Peripheral Component Interconnect (PCI) bus, or a bus such as a PCI Express bus or another third generation I/O interconnect bus, although the scope of the present disclosure is not so limited.

As shown in FIG. 14, various I/O devices 1414 may be coupled to first bus 1416, along with a bus bridge 1418 which couples first bus 1416 to a second bus 1420. In one embodiment, one or more additional processor(s) 1415, such as coprocessors, high-throughput MIC processors, GPGPU's, accelerators (such as, e.g., graphics accelerators or digital signal processing (DSP) units), field programmable gate arrays, or any other processor, are coupled to first bus 1416. In one embodiment, second bus 1420 may be a low pin count (LPC) bus. Various devices may be coupled to a second bus 1420 including, for example, a keyboard and/or mouse 1422, communication devices 1427 and a storage unit 1428 such as a disk drive or other mass storage device which may include instructions/code and data 1430, in one embodiment. Further, an audio I/O 1424 may be coupled to the second bus 1420. Note that other architectures are contemplated by this disclosure. For example, instead of the point-to-point architecture of FIG. 14, a system may implement a multi-drop bus or other such architecture.

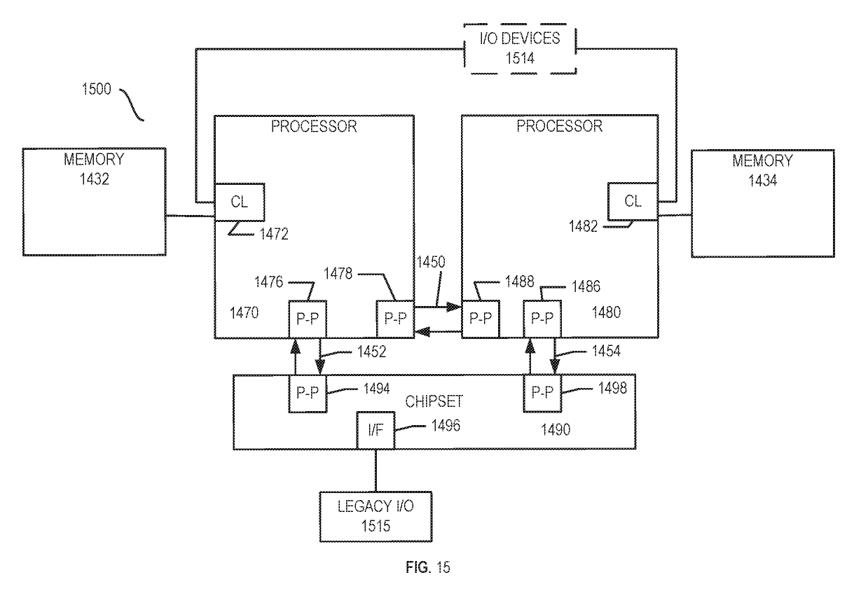

FIG. 15 depicts a block diagram of a second more specific exemplary system 1500 in accordance with an embodiment of the present disclosure. Similar elements in FIGS. 14 and 15 bear similar reference numerals, and certain aspects of FIG. 14 have been omitted from FIG. 15 in order to avoid obscuring other aspects of FIG. 15.

FIG. 15 illustrates that the processors 1470, 1480 may include integrated memory and I/O control logic (“CL”) 1472 and 1482, respectively. Thus, the CL 1472, 1482 include integrated memory controller units and include I/O control logic. FIG. 15 illustrates that not only are the memories 1432, 1434 coupled to the CL 1472, 1482, but also that I/O devices 1514 are also coupled to the control logic 1472, 1482. Legacy I/O devices 1515 are coupled to the chipset 1490.

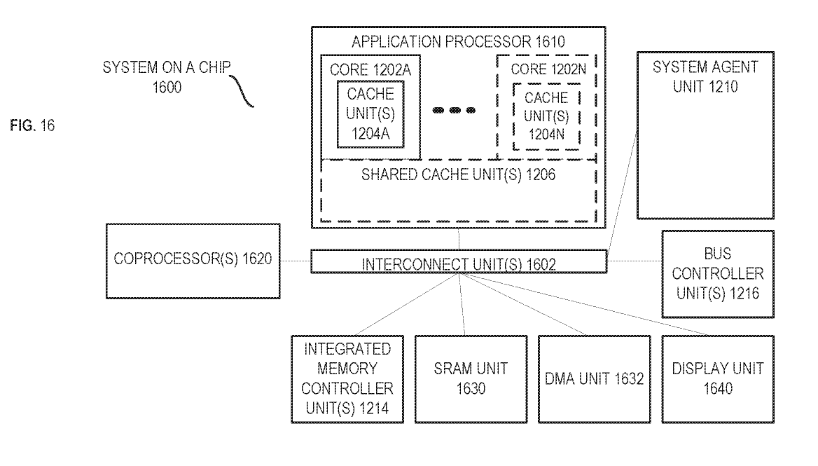

FIG. 16 depicts a block diagram of a SoC 1600 in accordance with an embodiment of the present disclosure. Similar elements in FIG. 12 bear similar reference numerals. Also, dashed lined boxes are optional features on more advanced SoCs. In FIG. 16, an interconnect unit(s) 1602 is coupled to: an application processor 1610 which includes a set of one or more cores 202A-N and shared cache unit(s) 1206; a system agent unit 1210; a bus controller unit(s) 1216; an integrated memory controller unit(s) 1214; a set or one or more coprocessors 1620 which may include integrated graphics logic, an image processor, an audio processor, and a video processor; an static random access memory (SRAM) unit 1630; a direct memory access (DMA) unit 1632; and a display unit 1640 for coupling to one or more external displays. In one embodiment, the coprocessor(s) 1620 include a special-purpose processor, such as, for example, a network or communication processor, compression and/or decompression engine, GPGPU, a high-throughput MIC processor, embedded processor, or the like.

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

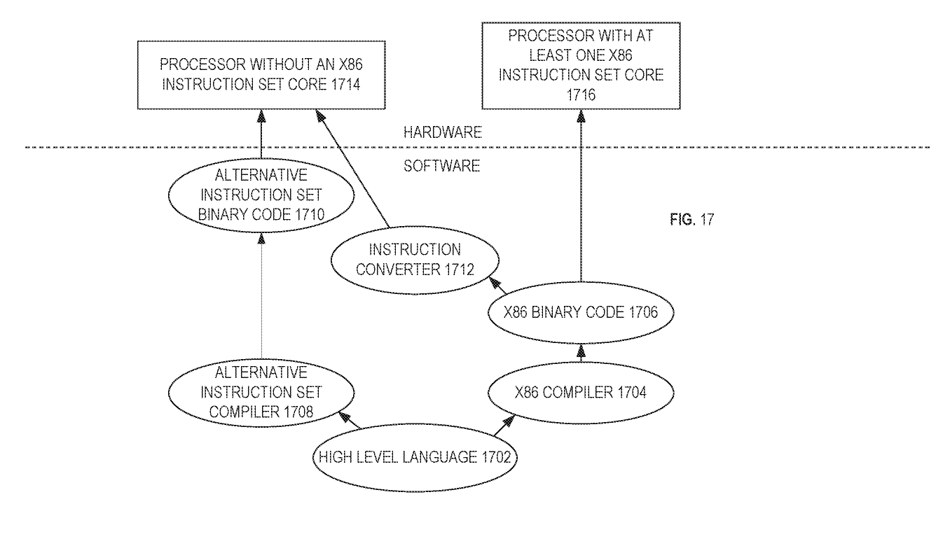

FIG. 17 is a block diagram contrasting the use of a software instruction converter to convert binary instructions in a source instruction set to binary instructions in a target instruction set according to embodiments of the disclosure. In the illustrated embodiment, the instruction converter is a software instruction converter, although alternatively the instruction converter may be implemented in software, firmware, hardware, or various combinations thereof. FIG. 17 shows a program in a high level language 1702 may be compiled using an x86 compiler 1704 to generate x86 binary code 1706 that may be natively executed by a processor with at least one x86 instruction set core 1716. The processor with at least one x86 instruction set core 1716 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 1704 represents a compiler that is operable to generate x86 binary code 1706 (e.g., object code) that can, with or without additional linkage processing, be executed on the processor with at least one x86 instruction set core 1716. Similarly, FIG. 17 shows the program in the high level language 1702 may be compiled using an alternative instruction set compiler 1708 to generate alternative instruction set binary code 1710 that may be natively executed by a processor without at least one x86 instruction set core 1714 (e.g., a processor with cores that execute the MIPS instruction set of MIPS Technologies of Sunnyvale, Calif. and/or that execute the ARM instruction set of ARM Holdings of Sunnyvale, Calif.). The instruction converter 1712 is used to convert the x86 binary code 1706 into code that may be natively executed by the processor without an x86 instruction set core 1714. This converted code is not likely to be the same as the alternative instruction set binary code 1710 because an instruction converter capable of this is difficult to make; however, the converted code will accomplish the general operation and be made up of instructions from the alternative instruction set. Thus, the instruction converter 1712 represents software, firmware, hardware, or a combination thereof that, through emulation, simulation or any other process, allows a processor or other electronic device that does not have an x86 instruction set processor or core to execute the x86 binary code 1706.

A design may go through various stages, from creation to simulation to fabrication. Data representing a design may represent the design in a number of manners. First, as is useful in simulations, the hardware may be represented using a hardware description language (HDL) or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In some implementations, such data may be stored in a database file format such as Graphic Data System II (GDS II), Open Artwork System Interchange Standard (OASIS), or similar format.

In some implementations, software based hardware models, and HDL and other functional description language objects can include register transfer language (RTL) files, among other examples. Such objects can be machine-parsable such that a design tool can accept the HDL object (or model), parse the HDL object for attributes of the described hardware, and determine a physical circuit and/or on-chip layout from the object. The output of the design tool can be used to manufacture the physical device. For instance, a design tool can determine configurations of various hardware and/or firmware elements from the HDL object, such as bus widths, registers (including sizes and types), memory blocks, physical link paths, fabric topologies, among other attributes that would be implemented in order to realize the system modeled in the HDL object. Design tools can include tools for determining the topology and fabric configurations of system on chip (SoC) and other hardware device. In some instances, the HDL object can be used as the basis for developing models and design files that can be used by manufacturing equipment to manufacture the described hardware. Indeed, an HDL object itself can be provided as an input to manufacturing system software to cause the manufacture of the described hardware.

In any representation of the design, the data representing the design may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

In various embodiments, a medium storing a representation of the design may be provided to a manufacturing system (e.g., a semiconductor manufacturing system capable of manufacturing an integrated circuit and/or related components). The design representation may instruct the system to manufacture a device capable of performing any combination of the functions described above. For example, the design representation may instruct the system regarding which components to manufacture, how the components should be coupled together, where the components should be placed on the device, and/or regarding other suitable specifications regarding the device to be manufactured.

Thus, one or more aspects of at least one embodiment may be implemented by representative instructions stored on a machine-readable medium which represents various logic within the processor, which when read by a machine causes the machine to fabricate logic to perform the techniques described herein. Such representations, often referred to as “IP cores” may be stored on a non-transitory tangible machine readable medium and supplied to various customers or manufacturing facilities to load into the fabrication machines that manufacture the logic or processor.

Embodiments of the mechanisms disclosed herein may be implemented in hardware, software, firmware, or a combination of such implementation approaches. Embodiments of the disclosure may be implemented as computer programs or program code executing on programmable systems comprising at least one processor, a storage system (including volatile and non-volatile memory and/or storage elements), at least one input device, and at least one output device.

Program code, such as code 1430 illustrated in FIG. 14, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In various embodiments, the language may be a compiled or interpreted language.

The embodiments of methods, hardware, software, firmware or code set forth above may be implemented via instructions or code stored on a machine-accessible, machine readable, computer accessible, or computer readable medium which are executable (or otherwise accessible) by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information therefrom.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

Logic may be used to implement any of the functionality of the various components such as branch prediction unit 100, primary branch predictor 102, secondary branch predictor 104, branch prediction logic 112, branch prediction logic 122, FHIT table 124, EICO tables 126, table update logic 128, misprediction count array 130, other component described herein, or any subcomponent of any of these components. “Logic” may refer to hardware, firmware, software and/or combinations of each to perform one or more functions. As an example, logic may include hardware, such as a micro-controller or processor, associated with a non-transitory medium to store code adapted to be executed by the micro-controller or processor. Therefore, reference to logic, in one embodiment, refers to the hardware, which is specifically configured to recognize and/or execute the code to be held on a non-transitory medium. Furthermore, in another embodiment, use of logic refers to the non-transitory medium including the code, which is specifically adapted to be executed by the microcontroller to perform predetermined operations. And as can be inferred, in yet another embodiment, the term logic (in this example) may refer to the combination of the hardware and the non-transitory medium. In various embodiments, logic may include a microprocessor or other processing element operable to execute software instructions, discrete logic such as an application specific integrated circuit (ASIC), a programmed logic device such as a field programmable gate array (FPGA), a memory device containing instructions, combinations of logic devices (e.g., as would be found on a printed circuit board), or other suitable hardware and/or software. Logic may include one or more gates or other circuit components, which may be implemented by, e.g., transistors. In some embodiments, logic may also be fully embodied as software. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices. Often, logic boundaries that are illustrated as separate commonly vary and potentially overlap. For example, first and second logic may share hardware, software, firmware, or a combination thereof, while potentially retaining some independent hardware, software, or firmware.

Use of the phrase ‘to’ or ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example, the decimal number ten may also be represented as a binary value of 1010 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

In at least one embodiment, a processor comprises a branch predictor to generate, in association with a program loop, a frozen history vector comprising a snapshot of a branch history vector; track a current iteration of the program loop; and provide a prediction for a branch instruction associated with the program loop, the prediction based on the frozen history vector and the current iteration of the program loop.

In an embodiment, the branch predictor is to maintain a data structure with a plurality of entries, an entry of the table to comprise an instruction pointer of the branch instruction, the current iteration of the program loop, and a dominant loop exit iteration count associated with the program loop. In an embodiment, the branch predictor is to predict a direction for the branch instruction based on whether the current iteration equals the dominant loop exit iteration count. In an embodiment, the branch predictor is to generate a plurality of frozen history vectors in association with the program loop, wherein each frozen history vector has a different length; and store at least one loop exit iteration count in association with each frozen history vector. In an embodiment, the branch predictor is to track the number of times a loop exit outcome coincides with a loop iteration count associated with the program loop. In an embodiment, the branch predictor is to detect an entry into a program loop based on whether a branch of the branch instruction is taken or not taken. In an embodiment, the branch predictor is to maintain a data structure associated with an instruction pointer of the branch instruction and the frozen history vector, wherein the data structure is to store, for a plurality of loop exit iteration counts, the number of times a loop exit outcome was detected for each loop exit iteration count. In an embodiment, the branch predictor is a secondary branch predictor that is to provide the prediction for the branch instruction in response to a determination that a primary branch predictor is not to provide a prediction for the branch instruction. In an embodiment, the processor is to determine that the secondary branch predictor is to provide the prediction based at least in part on an indication of the number of times that the primary branch predictor has mispredicted the branch instruction. In an embodiment, the processor is to determine that the secondary branch predictor is to provide the prediction based at least in part on a saturation of a misprediction counter value associated with the branch instruction.

In at least one embodiment, a method comprising generating, in association with a program loop, a frozen history vector comprising a snapshot of a branch history vector; tracking a current iteration of the program loop; and providing a prediction for a branch instruction associated with the program loop, the prediction based on the frozen history vector and the current iteration of the program loop.

In an embodiment, the method further comprises maintaining a data structure with a plurality of entries, an entry of the table to comprise an instruction pointer of the branch instruction, the current iteration of the program loop, and a dominant loop exit iteration count associated with the program loop. In an embodiment, the method further comprises predicting a direction for the branch instruction based on whether the current iteration equals the dominant loop exit iteration count. In an embodiment, the method further comprises generating a plurality of frozen history vectors in association with the program loop, wherein each frozen history vector has a different length; and storing at least one loop exit iteration count in association with each frozen history vector. In an embodiment, the method further comprises tracking the number of times a loop exit outcome coincides with a loop iteration count associated with the program loop. In an embodiment, the method further comprises detecting an entry into a program loop based on whether a branch of the branch instruction is taken or not taken. In an embodiment, the method further comprises maintaining a data structure associated with an instruction pointer of the branch instruction and the frozen history vector, wherein the data structure is to store, for a plurality of loop exit iteration counts, the number of times a loop exit outcome was detected for each loop exit iteration count. In an embodiment, the method further comprises providing, by a secondary branch predictor, the prediction for the branch instruction in response to a determination that a primary branch predictor is not to provide a prediction for the branch instruction. In an embodiment, the method further comprises determining that the secondary branch predictor is to provide the prediction based at least in part on an indication of the number of times that the primary branch predictor has mispredicted the branch instruction. In an embodiment, the method further comprises determining that the secondary branch predictor is to provide the prediction based at least in part on a saturation of a misprediction counter value associated with the branch instruction.

In at least one embodiment, a system comprises means for generating, in association with a program loop, a frozen history vector comprising a snapshot of a branch history vector; means for tracking a current iteration of the program loop; and means for providing a prediction for a branch instruction associated with the program loop, the prediction based on the frozen history vector and the current iteration of the program loop.

In an embodiment, the system further comprises means for maintaining a data structure with a plurality of entries, an entry of the table to comprise an instruction pointer of the branch instruction, the current iteration of the program loop, and a dominant loop exit iteration count associated with the program loop. In an embodiment, the system further comprises means for predicting a direction for the branch instruction based on whether the current iteration equals the dominant loop exit iteration count. In an embodiment, the system further comprises means for generating a plurality of frozen history vectors in association with the program loop, wherein each frozen history vector has a different length; and means for storing at least one loop exit iteration count in association with each frozen history vector. In an embodiment, the system further comprises means for tracking the number of times a loop exit outcome coincides with a loop iteration count associated with the program loop.

In at least one embodiment, a non-transitory machine readable storage medium has instructions stored thereon, the instructions when executed by a machine to cause the machine to generate, in association with a program loop, a frozen history vector comprising a snapshot of a branch history vector; track a current iteration of the program loop; and provide a prediction for a branch instruction associated with the program loop, the prediction based on the frozen history vector and the current iteration of the program loop.

In an embodiment, the instructions when executed to further cause the machine to maintain a data structure with a plurality of entries, an entry of the table to comprise an instruction pointer of the branch instruction, the current iteration of the program loop, and a dominant loop exit iteration count associated with the program loop. In an embodiment, the instructions when executed to further cause the machine to predict a direction for the branch instruction based on whether the current iteration equals the dominant loop exit iteration count. In an embodiment, the instructions when executed to further cause the machine to generate a plurality of frozen history vectors in association with the program loop, wherein each frozen history vector has a different length; and store at least one loop exit iteration count in association with each frozen history vector. In an embodiment, the instructions when executed to further cause the machine to track the number of times a loop exit outcome coincides with a loop iteration count associated with the program loop.

In at least one embodiment, a system comprises a processor comprising a primary branch detector to provide predictions for a plurality of branch instructions; and a secondary branch detector to generate, in association with a program loop, a frozen history vector comprising a snapshot of a branch history vector; track a current iteration of the program loop; and provide a prediction for a branch instruction associated with the program loop, the prediction based on the frozen history vector and the current iteration of the program loop.

In an embodiment, the processor further comprises a memory to store a data structure comprising a plurality of entries, an entry of the data structure to comprise an instruction pointer of the branch instruction, the current iteration of the program loop, and a dominant loop exit iteration count associated with the program loop. In an embodiment, the secondary branch predictor is to predict a direction for the branch instruction based on whether the current iteration equals the dominant loop exit iteration count. In an embodiment, the secondary branch predictor is to generate a plurality of frozen history vectors in association with the program loop, wherein each frozen history vector has a different length; and store at least one loop exit iteration count in association with each frozen history vector. In an embodiment, the secondary branch predictor is to track the number of times a loop exit outcome coincides with a loop iteration count associated with the program loop.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. A processor comprising:
a branch predictor to:
generate, in association with a program loop, a frozen history vector comprising a snapshot of a branch history vector;
track a current iteration of the program loop; and
provide a prediction for a branch instruction associated with the program loop, the prediction based on the frozen history vector and the current iteration of the program loop.

2. The processor of claim 1, wherein the branch predictor is to maintain a data structure with a plurality of entries, an entry of the table to comprise an instruction pointer of the branch instruction, the current iteration of the program loop, and a dominant loop exit iteration count associated with the program loop.

3. The processor of claim 2, wherein the branch predictor is to predict a direction for the branch instruction based on whether the current iteration equals the dominant loop exit iteration count.

4. The processor of claim 1, wherein the branch predictor is to:
generate a plurality of frozen history vectors in association with the program loop, wherein each frozen history vector has a different length; and
store at least one loop exit iteration count in association with each frozen history vector.

5. The processor of claim 1, wherein the branch predictor is to track the number of times a loop exit outcome coincides with a loop iteration count associated with the program loop.

6. The processor of claim 1, wherein the branch predictor is to detect an entry into a program loop based on whether a branch of the branch instruction is taken or not taken.

7. The processor of claim 1, wherein the branch predictor is to maintain a data structure associated with an instruction pointer of the branch instruction and the frozen history vector, wherein the data structure is to store, for a plurality of loop exit iteration counts, the number of times a loop exit outcome was detected for each loop exit iteration count.

8. The processor of claim 1, wherein the branch predictor is a secondary branch predictor that is to provide the prediction for the branch instruction in response to a determination that a primary branch predictor is not to provide a prediction for the branch instruction.

9. The processor of claim 8, wherein the processor is to determine that the secondary branch predictor is to provide the prediction based at least in part on an indication of the number of times that the primary branch predictor has mispredicted the branch instruction.

10. The processor of claim 8, wherein the processor is to determine that the secondary branch predictor is to provide the prediction based at least in part on a saturation of a misprediction counter value associated with the branch instruction.

11. A method comprising:
generating, in association with a program loop, a frozen history vector comprising a snapshot of a branch history vector;
tracking a current iteration of the program loop; and
providing a prediction for a branch instruction associated with the program loop, the prediction based on the frozen history vector and the current iteration of the program loop.

12. The method of claim 11, further comprising maintaining a data structure with a plurality of entries, an entry of the table to comprise an instruction pointer of the branch instruction, the current iteration of the program loop, and a dominant loop exit iteration count associated with the program loop.

13. The method of claim 12, further comprising predicting a direction for the branch instruction based on whether the current iteration equals the dominant loop exit iteration count.

14. The method of claim 11, further comprising:
generating a plurality of frozen history vectors in association with the program loop, wherein each frozen history vector has a different length; and
storing at least one loop exit iteration count in association with each frozen history vector.

15. The method of claim 11, further comprising tracking the number of times a loop exit outcome coincides with a loop iteration count associated with the program loop.

16. A system comprising:
a processor comprising:
a primary branch detector to provide predictions for a plurality of branch instructions; and
a secondary branch detector to:
generate, in association with a program loop, a frozen history vector comprising a snapshot of a branch history vector;
track a current iteration of the program loop; and
provide a prediction for a branch instruction associated with the program loop, the prediction based on the frozen history vector and the current iteration of the program loop.

17. The system of claim 16, the processor further comprising a memory to store a data structure comprising a plurality of entries, an entry of the data structure to comprise an instruction pointer of the branch instruction, the current iteration of the program loop, and a dominant loop exit iteration count associated with the program loop.

18. The system of claim 17, wherein the secondary branch predictor is to predict a direction for the branch instruction based on whether the current iteration equals the dominant loop exit iteration count.

19. The system of claim 16, wherein the secondary branch predictor is to:
generate a plurality of frozen history vectors in association with the program loop, wherein each frozen history vector has a different length; and
store at least one loop exit iteration count in association with each frozen history vector.

20. The system of claim 16, wherein the secondary branch predictor is to track the number of times a loop exit outcome coincides with a loop iteration count associated with the program loop.
